(19) United States
(12) Patent Application Publication
(10) Pub. No.: US 2026/0319177 A1
(43) Pub. Date: Oct. 15, 2026

(54) COMPOSITE COMPONENT FOR OPTICAL LIGHT GUIDE ELEMENTS AND METHOD FOR PRODUCTION THEREOF

(71) Applicants: SCHOTT AG, Mainz (DE); SCHOTT Glass (Malaysia) SDN BHD, Penang (MY)

(72) Inventors: Stefan WEIDLICH, Mainz (DE); Hon Lun LIM, Penang (MY); Fangtong XIE, Mainz (DE)

(73) Assignees: SCHOTT AG, Mainz (DE); SCHOTT Glass (Malaysia) SDN BHD, Penang (MY)

(21) Appl. No.: 19/484,925

(22) PCT Filed: May 17, 2024
(86) PCT No.: PCT/EP2024/063759

§ 371 Date: Nov. 17, 2025

(30) Foreign Application Priority Data
May 19, 2023 (EP) 23174329.5

(51) Int. Cl. G02B 6/126; B32B 7/12; B32B 17/06; G02B 1/10

(52) U.S. Cl. CPC G02B 6/126; B32B 7/12; B32B 17/06; G02B 1/10; B32B 2255/20; B32B 2307/418; B32B 2307/7376; B32B 2551/00

(57) ABSTRACT

The present invention relates to an optical composite component, in particular for use as an optical light guide element or in an optical light guide element, and to methods for the production thereof. Furthermore, the invention includes the use of the optical composite component as or in an optical light guide element, in particular in the field of augmented reality.

The present invention relates to a method for producing an optical composite component, in particular for use as an optical light guide element or in an optical light guide element, and to an optical composite component. Furthermore, the invention comprises the use of the optical composite component as or in an optical light guide element, in particular in the field of augmented reality.

Light guide elements fulfill a central function in imaging optical systems for augmented reality applications. Such imaging optical systems in the area of augmented reality can be, for example, wearable systems fastened on the head, in which an image is additionally presented to a user in their field of view. Additional information can be displayed to the user in a variety of ways by the additional image, for instance in order to display nonvisible elements to an operator in medicine, which were previously recorded by means of tomography, for example. Other applications relate to navigation, for example in the aircraft or also in vehicles. Diffractive or reflective optical elements can be used in this case.

Such imaging optical systems can comprise an eyepiece in this case in order to visualize images projected thereon to the user. The eyepieces can comprise very thin, preferably highly refractive optical glasses or a composite having corresponding very thin optical materials, for example glasses.

Light guide elements, in particular in the case of use of a composite of multiple thin optical materials, or substrates, have to have high requirements with respect to the internal quality of the substrates, or wafers, installed therein and also a precisely set geometry of the individual substrates and the light guide elements produced therefrom. Such light guide elements typically comprise a plurality of coated and/or uncoated substrates which are connected to one another using an adhesive, for example. Optical components are subsequently obtained from the stack obtained in this case by isolation steps. These optical components can, on the one hand, be used as light guides directly after the isolation and possibly after a posttreatment of the surface(s). In other cases, the obtained stack is connected, or adhesively bonded, to further optical components, such as mirrors, filters, polarization optical units, and light guide elements are obtained from the component thus resulting by isolation steps. The isolation is carried out, for example by means of sawing, for example a wire saw or a multi-wire saw. The composite components obtained after the dividing step typically still do not have a surface quality required for the use as the optical light guide component, in particular with regard to the surface roughness or the total thickness variation (TTV). This can result in optical losses, for example due to scattering of light during the use as a light guide element and can thus disadvantageously influence the resulting imaging quality.

Therefore, after the dividing steps, postprocessing of the optically relevant surfaces of the light guide elements typically follows, for example by lapping and/or polishing steps. However, these postprocessing steps—in particular with optically relevant surfaces which comprise areas made of different materials—can have the result that the material removal due to the postprocessing steps takes place unevenly, because of which the processed surfaces have irregularities, in particular local depressions or elevations. Such irregularities can in turn result in undesired optical losses and as a consequence in worse imaging quality. The postprocessing of the surfaces of light guide elements therefore has to be carried out so that, on the one hand, the desired surface roughness or total thickness variation of the optically relevant surfaces is achieved; on the other hand, the generation of irregularities is avoided or reduced as much as possible.

It was therefore an object of the present invention to provide a corresponding method for surface modification.

The object was achieved in a first aspect in particular by a method for surface modification of an optical composite component,
wherein the optical composite component has a first surface and a second surface,
wherein the optical composite component comprises at least one stack having a first and a second surface,
wherein the at least one stack comprises two or more substrates, at least one inorganic coating and at least one adhesive layer, wherein the two or more substrates and the at least one inorganic coating are arranged alternately along the stack direction,
wherein the angle between the normal vector of the first and/or of the second surface of the at least one stack and the stack direction is not equal to 0°,
wherein the first surface of the composite component comprises the first surface of the at least one stack and/or the second surface of the composite component comprises the second surface of the at least one stack,
comprising the following steps:
   a) providing a raw composite component;
   b) optionally lapping or grinding at least one area of the first and/or of the second surface of the raw composite component;
   c) polishing at least one area of the first surface and/or of the second surface of the raw composite component, preferably with a surface removal of 30 μm to 60 μm, preferably of 40 μm to 60 μm and/or a pressure of 50 to 1500 N, preferably of 100 N to 500 N, and/or a rotational speed of 5 to 20 rpm, preferably of 5 to 15 rpm, and/or a slurry density of 1.02 to 1.1 g/cm³, preferably of 1.04 g/cm³ to 1.07 g/cm³.

It has been found that the method according to the invention results in optical composite components which, in addition to a low surface roughness and possibly a low total thickness variation, also fulfills the high requirements for the planarity of the surfaces, in particular the optically relevant areas of the surfaces.

### Step a) Providing the Raw Composite Component and Raw Composite Component

In step a) of the method according to the invention, a raw composite component is provided.

According to the invention, the raw composite component has a first surface and a second surface. The first and the second surface of the raw composite component are the so-called “main surfaces” of the raw composite component. The distance from the first to the second surface of the raw composite component is also referred to hereinafter as the thickness of the raw composite component.

Preferably, the raw composite component has a thickness of 0.2 mm to 2.0 mm, preferably of 0.3 mm to 1.8 mm, preferably of 0.4 to 1.7 mm, and particularly preferably of 0.5 to 1.5 mm.

The raw composite component is preferably disk-shaped, wherein the first and the second surface are opposite to one another, preferably are parallel to one another. The maximum distance of the first surface to the second surface, in other words the thickness of the raw composite component, is preferably less than the maximum width and/or the maximum length or the maximum diameter of the first or second surface of the raw composite component.

The disk-shaped raw composite component can be—with respect to the first and second surface—polygonal or round, or can have both corners and rounded areas.

Preferably, the raw composite component—with respect to the first and the second surface—is polygonal.

The raw composite component preferably has a length and/or width of 10 mm to 300 mm, preferably of 20 mm to 150 mm, more preferably 30 mm to 100 mm, for example of 50 mm to 80 mm and/or a diameter of 10 mm to 300 mm, preferably 15 mm to 200 mm, preferably of 20 mm to 150 mm, more preferably 30 mm to 100 mm, for example of 50 mm to 80 mm.

According to the invention, the raw composite component comprises at least one stack having a first and a second surface, wherein the stack comprises two or more substrates, at least one inorganic coating and at least one adhesive layer, wherein the two or more substrates and the at least one inorganic coating are arranged alternately along the stack direction.

A detailed description and preferred features and areas with regard to the substrates, the inorganic coating and the adhesive layer will be described hereinafter in conjunction with the optical composite component according to the invention and apply analogously in conjunction with the raw composite component-if applicable.

According to the invention, the angle between the normal vector of the first and/or of the second surface of the at least one stack and the stack direction is not equal to 0°.

The stack direction is understood as the stacking along the normal vector of the boundary surface between the at least two substrates. The boundary surface is preferably formed by the inorganic coating and/or the adhesive layer.

According to the invention, the first surface of the composite component comprises the first surface of the at least one stack and/or the second surface of the composite component comprises the second surface of the at least one stack. In other words, the first surface of the first stack forms at least one part of the first surface of the raw composite component and/or the second surface of the at least one stack forms at least a part of the second surface of the raw composite component. The first and/or the second surface of the raw composite component therefore comprises areas which form boundary surfaces between the two or more substrates; preferably, the surface of the raw composite component comprises areas which comprise inorganic coating and/or adhesive layers.

In one embodiment, the raw composite component consists of the at least one stack, wherein the first surface of the raw composite component consists of the first surface of the at least one stack and the second surface of the raw composite component consists of the second surface of the at least one stack.

In one preferred embodiment, the absolute value of the angle between normal vector of the first and/or of the second surface of the at least one stack and the stack direction is 90°.

In another preferred embodiment, the absolute value of the angle between normal vector of the first and/or of the second surface of the at least one stack and the stack direction is >10°, preferably >20°, preferably >45°, more preferably >50°, particularly preferably >55° or >60°.

The absolute value of the angle between normal vector of the first and/or of the second surface of the at least one stack and the stack direction is preferably in a range of greater than 10° to 90°, preferably of greater than 20° to 90°, also preferably of greater than 45° and 90°, more preferably of greater than 50° to 90°, and particularly preferably of greater than 55° to 90° or of greater than 60° and 90°.

In one embodiment, the raw composite component consists of the at least one stack.

In another embodiment, the raw composite component comprises at least one further stack and/or at least one further optical component, selected from optical filters, in particular interference filters, mirrors, optical light guide elements and polarization-optical elements, also called polarization optics hereinafter. In some embodiments, the raw composite component furthermore comprises further optically nonrelevant components, in particular optically nonrelevant components comprising or consisting of the material of which at least one substrate consists or which at least one substrate comprises.

Optical components in the meaning of the invention are components which comprise one or more optically relevant areas, wherein an optically relevant area is understood as an area of a component which is in the beam path of the optically relevant light. Optically relevant light in the meaning of the present invention is the light which provides a contribution to the resulting image. Optically relevant areas of an optical component according to the invention are the areas which are in the beam path of the light. An optically relevant area of the surface of a specific component in the meaning of the invention is understood as any surface which is in the beam path of the optically relevant light, which comprises both surfaces on the light incidence side and on the light emission side and surfaces which reflect or deflect the incident light beam.

In some embodiments, the raw composite component comprises at least one polarization-optical element, wherein the polarization-optical element has a first surface and a second surface, and wherein the first surface of the composite component comprises the first surface of the polarization-optical element and/or the second surface of the composite component comprises the second surface of the polarization-optical element.

In advantageous embodiments, the first surface and the second surface of the raw composite component are parallel to one another and/or the first surface of the at least one stack and the second surface of the at least one stack are parallel to one another.

Because of production, the raw composite component typically has a total thickness variation of up to 10 μm, up to 5 μm, up to 3 μm, or up to 2 μm, with respect to the first and the second surface of the raw composite component, and/or a roughness R_{q} of the first and/or second surface of the raw composite component of greater than 100 nm, greater than 200 nm, greater than 300 nm, greater than 400 nm, or greater than 500 nm.

The total thickness variation (TTV) can be determined, for example, according to SEMI MF 1530GBIR. The total thickness variation can also be determined by means of interferometric measurements of the thickness profile of the substrates, for example using an interferometer, in particular an interferometer from the Zygo Corporation.

If roughness is referred to in conjunction with the invention, roughness—if not indicated otherwise—means the roughness R_{q}, the root mean square roughness, also referred to as RMS (“root mean squared”), which are measured, for example, by means of white light interferometers or AFM technology, preferably according to DIN EN ISO 4287. The measurement is carried out at the areas of the surface of the (raw) composite components which does not comprise an adhesive layer, an inorganic coating or any crystalline or organic areas. The indicated roughness therefore relates in each case to selected areas of the (raw) composite surface which does not comprise an adhesive layer, an inorganic coating or any crystalline or organic areas.

Because of production, the raw composite component does not have the required surface quality in order to have the desired outstanding optical properties which are advantageous for the use in an optical light guide element.

In particular raw composite components which are obtained by one or more dividing steps, for example by means of a wire saw, have a disadvantageously high roughness and/or a comparatively high total thickness variation on the first and/or the second surface.

### Step b) Lapping or Grinding

Optionally, in one embodiment, in step b) of the method according to the invention, at least one area of the first and/or of the second surface of the raw composite component, preferably the entire first and/or second surface of the raw composite component, is lapped or ground first.

Preferably, a surface removal of 50 μm to 400 μm, preferably of 80 to 300 μm, preferably of 100 to 300 μm, takes place during the lapping or grinding. Lapping is preferably carried out at a pressure of 50 N to 1500 N, preferably of 100 N to 500 N.

In advantageous embodiments, the rotational speed during the lapping or grinding is 5 to 20 rpm, preferably 5 to 15 rpm, wherein the pad preferably comprises resin-bound diamond.

Lapping or grinding preferably takes place using a coolant concentration of 10 vol % to 20 vol %.

In particular in embodiments in which the raw composite component provided in step a) of the method according to the invention has a comparatively high total thickness variation because of production, lapping or grinding of the raw composite component can be advantageous.

Lapping or grinding can be carried out in a single-sided or double-sided manner.

In particularly advantageous embodiments, the method according to the invention does not comprise lapping or grinding of the raw composite component.

### Step c) Polishing

According to the invention, the method comprises in step c) polishing at least one area of the first surface and/or of the second surface of the raw composite component. Preferably, the entire first and/or second surface of the raw composite component is polished, wherein an optical composite component is obtained, preferably having a surface removal of 30 μm to 60 μm, preferably of 40 μm to 60 μm and/or a pressure of 50 to 1500 N, preferably of 100 N to 500 N, and/or a rotational speed of 5 to 20 rpm, preferably of 5 to 15 rpm, and/or a slurry density of 1.02 to 1.1 g/cm³, preferably of 1.04 g/cm³ to 1.07 g/cm³.

In advantageous embodiments, the slurry comprises CeO₂.

Polishing can comprise one or more polishing steps. Polishing can be carried out in a single-sided or double-sided manner.

It has been found that using the described parameter, optical composite components having low surface roughness and/or a low total thickness variation and at the same time small irregularities on the surfaces are obtained.

The optical composite component obtained in step c) can be further processed depending on its use, for example by CNC milling or other forming methods and/or can be connected to further, preferably optical components, for example prisms, mirrors, polarization-optical elements.

The object was achieved in a second aspect by an optical composite component in particular for use as an optical light guide element or in an optical light guide element, producible or produced in an advantageous embodiment by means of the above-mentioned method,
wherein the optical composite component has a first surface and a second surface,
   wherein the optical composite component comprises at least one stack having a first and a second surface,
   wherein the stack comprises two or more substrates, at least one inorganic coating and at least one adhesive layer, wherein the two or more substrates and the at least one inorganic coating are arranged alternately along the stack direction,
   wherein the first and/or the second surface of the at least one stack is planar and does not have a deviation from the plane of more than 500 nm,
   wherein the angle between normal vector of the first and/or of the second surface of the at least one stack and the stack direction is not equal to 0°,
   and wherein the first surface of the composite component comprises the first surface of the at least one stack and/or the second surface of the composite component comprises the second surface of the at least one stack.

In one advantageous embodiment, the first surface and the second surface of the optical composite component are parallel to one another and/or the first surface of the at least one stack and the second surface of the at least one stack are parallel to one another.

The distance from the first to the second surface of the optical composite component is also referred to hereinafter as the thickness of the composite component. Preferably, the optical composite component and/or the at least one stack has a thickness of 0.2 mm to 2.0 mm, preferably of 0.3 mm to 1.8 mm, preferably of 0.4 to 1.7 mm, and particularly preferably of 0.5 to 1.5 mm.

In embodiments in which the first surface and the second surface of the optical composite component are not parallel to one another, the thickness of the composite component varies, wherein the maximum thickness and the minimum thickness of the composite component are in the range of 0.2 mm to 2.0 mm, preferably of 0.3 mm to 1.8 mm, preferably of 0.4 to 1.7 mm, and particularly preferably of 0.5 to 1.5 mm.

The optical composite component is preferably disk-shaped, wherein the first and the second surface are opposite to one another, preferably are parallel to one another. Preferably, the maximum distance of the first surface to the second surface, in other words the thickness of the optical composite component, is less than the maximum width and/or the maximum length or the maximum diameter of the first or second surface of the optical composite component.

The preferably disk-shaped optical composite component can be—with respect to the first and second surface—polygonal or round, or can have both corners and rounded areas.

Optical composite components preferably have a length and/or width of 10 mm to 300 mm, preferably of 20 mm to 150 mm, more preferably 30 mm to 100 mm, for example of 50 mm to 80 mm and/or a diameter of 10 mm to 300 mm, preferably 15 mm to 200 mm, preferably of 20 mm to 150 mm, more preferably 30 mm to 100 mm, for example of 50 mm to 80 mm.

According to the invention, the optical composite component has at least one stack having a first and a second surface, wherein the stack comprises two or more substrates, at least one inorganic coating and at least one adhesive layer, wherein the two or more substrates and the at least one inorganic coating are arranged alternately along the stack direction.

According to the invention, the angle between the normal vector of the first and/or of the second surface of the at least one stack and the stack direction is not equal to 0°.

Stack direction is understood as the stacking along the normal vector of the boundary surface between the at least two substrates. Preferably, the boundary surface is formed by the inorganic coating and/or the adhesive layer.

According to the invention, the first surface of the optical composite component comprises the first surface of the at least one stack and/or the second surface of the optical composite component comprises the second surface of the at least one stack. In other words, the first surface of the first stack forms at least one part of the first surface of the optical composite component and/or the second surface of the at least one stack forms at least one part of the second surface of the optical composite component. The first and/or the second surface of the optical composite component therefore comprises areas which form boundary surfaces between the two or more substrates; preferably, the surface of the optical composite component comprises areas which comprise inorganic coating and/or adhesive layers.

In one embodiment, the optical composite component consists of the at least one stack, wherein the first surface of the optical composite component consists of the first surface of the at least one stack and the second surface of the optical composite component consists of the second surface of the at least one stack.

In one preferred embodiment, the absolute value of the angle between normal vector of the first and/or of the second surface of the at least one stack and the stack direction is 90°.

In another preferred embodiment, the absolute value of the angle between normal vector of the first and/or of the second surface of the at least one stack and the stack direction is >10°, preferably >20°, preferably >45°, more preferably >50°, particularly preferably >55° or >60°.

The absolute value of the angle between normal vector of the first and/or of the second surface of the at least one stack and the stack direction is preferably in a range of greater than 10° to 90°, preferably of greater than 20° to 90°, also preferably of greater than 45° and 90°, more preferably of greater than 50° to 90°, and particularly preferably of greater than 55° to 90° or of greater than 60° and 90°.

In one embodiment, the optical composite component consists of the at least one stack.

In another embodiment, the optical composite component comprises at least one further stack and/or at least one further optical component, selected from optical filters, in particular interference filters, mirrors, optical light guide elements and polarization-optical elements, also called polarization optics hereinafter. In some embodiments, the composite component furthermore comprises further optically nonrelevant components, preferably optically nonrelevant components comprising or consisting of the material of which at least one substrate consists or which at least one substrate comprises.

In some embodiments, the composite component comprises a polarization-optical element, wherein the polarization-optical element has a first surface and a second surface, wherein the first surface of the composite component comprises the first surface of the polarization-optical element and/or the second surface of the composite component comprises the second surface of the polarization-optical element.

Polarization-optical elements in the meaning of the present invention are elements which create the path difference between two partial waves which are linearly polarized perpendicular to one another and the oscillation directions of which correspond to the distinguished directions of this optical element. In particular, such polarization-optical elements are used to select a specific polarization of the light and/or to generate or rotate a specific polarization direction of the light. Such polarization-optical elements can be, for example, reflective, transmissive, dichroic and birefringent elements.

The polarization-optical element preferably comprises a birefringent material, preferably a birefringent crystal or a birefringent polymer. The birefringent material is preferably a birefringent crystal, in particular quartz, MgF₂ or CaF₂, or a birefringent polymer. The birefringent material is particularly preferably quartz.

The polarization-optical element preferably has a length of 10 mm to 300 mm, preferably of 20 mm to 150 mm, more preferably 30 mm to 100 mm, for example of 50 mm to 80 mm and/or a width of 1 μm to 100 μm, preferably of 5 μm to 50 μm, and particularly preferably of 20 μm to 40 μm.

According to the invention, the first and/or the second surface of the at least one stack is planar; preferably, the first and the second surface of the at least one stack are planar.

Preferably, the first and/or the second surface of the optical composite component is planar; preferably, the first and the second surface of the optical composite component are planar.

Preferably, the optically relevant areas of the first and/or of the second surfaces of the composite component are planar.

“Planarity” or “planar” in the meaning of the invention means that the observed surface does not have a deviation from the plane formed by the observed surface of greater than a defined absolute value.

According to the invention, “planarity” or “planar” in conjunction with the at least one stack means that the first and/or the second surface of the at least one stack does not have a deviation from the plane of greater than 1000 nm.

Preferably, “planarity” or “planar” in conjunction with the optical composite component means that the first and/or the second surface of the optical composite component does not have a deviation from the plane of greater than 1000 μm.

Preferably, “planarity” or “planar” in conjunction with the polarization-optical element means that the first and/or the second surface of the polarization-optical element does not have a deviation from the plane of greater than 1000 nm.

Preferably, “planarity” or “planar” in conjunction with the optically relevant areas of the surfaces of the composite component means that the optically relevant areas of the first and/or of the second surfaces of the composite component do not have a deviation from the plane of greater than 1000 nm.

A “plane” of an observed surface is defined in that a surface is approximated by a regression of a mathematically perfect two-dimensional plane such that the deviations of the real topography of the observed surface from the regression plane are minimized in both spatial directions.

The height or depression of deviations of the plane thus determined is determined in that the distance of a point (preferably the highest point of an elevation or the lowest point of a depression) from the plane is measured along the normal vector of the plane. Elevations or depression can be determined, for example, by means of AFM measurements.

Because of production, but independently of the special production method, the first and/or the second surface of the at least one stack and/or the first and/or second surface of the optical composite component according to the invention can have deviations from the ideal planes, in particular elevations and depressions. Such deviations can arise in particular during abrasive processes, such as grinding, lapping or polishing of the respective surfaces during the production of the optical composite component, above all in the partial areas of the surface which differ in their hardnesses, their modulus of elasticity, their elongation at fracture behavior, their glass transition temperature T_{g} or their tensile strength.

In the optical composite component according to the invention, such deviations occur in particular in the areas of the surface which are formed by the first or the second surface of the at least one stack and therefore have boundary surfaces comprising at least one inorganic coating and/or one adhesive layer.

In some embodiments, the first and/or the second surface of the at least one stack has elevations, which is localized at least partially on the area of the surface which comprises or consists of at least one inorganic coating.

In some embodiments, the first and/or the second surface of the at least one stack has elevations, which is localized at least partially on the area of the surface which comprises or consists of at least one adhesive layer.

In some embodiments, the first and/or the second surface of the at least one stack has depressions, which is localized at least partially on the area of the surface which comprises or consists of at least one inorganic coating.

In some embodiments, the first and/or the second surface of the at least one stack has depressions, which is localized at least partially on the area of the surface which comprises or consists of at least one adhesive layer.

In some embodiments, the first and/or the second surface of the at least one stack has elevations, which is localized at least partially on the area of the surface which comprises or consists of at least one inorganic coating, and/or depressions, which is localized at least partially on the area of the surface which comprises or consists of at least one adhesive layer.

In some embodiments, the first and/or the second surface of the at least one stack has elevations, which is localized at least partially on the area of the surface which comprises or consists of at least one adhesive layer, and/or depressions, which is localized at least partially on the area of the surface which comprises or consists of at least one inorganic coating.

According to the invention, the first and/or the second surface of the at least one stack do not have deviations from the plane of greater than 500 nm, preferably not greater than 300 nm, preferably not greater than 150 nm or not greater than 120 nm, preferably not greater than 100 nm, and particularly preferably not greater than 80 nm or not greater than 70 nm, furthermore particularly preferably not greater than 60 nm or 50 nm.

Preferably, the first and/or the second surface of the optical composite component do not have deviations from the plane of greater than 1000 μm, preferably not greater than 500 μm, more preferably not greater than 250 μm or not greater than 100 μm. In some preferred embodiments, the first and/or the second surface of the optical composite component do not have deviations from the plane of greater than 1 μm, preferably not greater than 500 nm, preferably not greater than 300 nm, preferably not greater than 150 nm or not greater than 120 nm, preferably not greater than 100 nm, and particularly preferably not greater than 80 nm or not greater than 70 nm, furthermore particularly preferably not greater than 60 nm or 50 nm.

In embodiments of the optical composite component which have at least one further stack, this stack does not have deviations from the plane of greater than 1 μm, preferably not greater than 500 nm, preferably not greater than 300 nm, preferably not greater than 150 nm or not greater than 120 nm, preferably not greater than 100 nm, and particularly preferably not greater than 80 nm or not greater than 70 nm, furthermore particularly preferably not greater than 60 nm or 50 nm.

In some embodiments, the first and/or the second surface of the at least one stack preferably has deviations from the plane in the range of 5 nm to 1 μm, preferably of 5 nm to 500 nm, more preferably of 10 nm to 300 nm or of 10 nm to 150 nm, particularly preferably of 20 nm to 100 nm, and likewise particularly preferably of 20 nm to 60 nm.

Preferably, the optically relevant areas of the first and/or of the second surface of the optical composite component do not have deviations from the plane of greater than 10 μm, preferably not greater than 5 μm, more preferably not greater than 2 μm or not greater than 1 μm. In some embodiments, the optically relevant areas of the first and/or of the second surface of the optical composite component do not have deviations from the plane of greater than 500 nm, preferably not greater than 300 nm, preferably not greater than 150 nm or not greater than 120 nm, preferably not greater than 100 nm, and particularly preferably not greater than 80 nm or not greater than 70 nm, furthermore particularly preferably not greater than 60 nm or 50 nm.

Preferably, the first and/or the second surface of the polarization-optical element do not have deviations from the plane of greater than 1 μm, preferably not greater than 500 nm, preferably not greater than 300 nm, preferably not greater than 150 nm or not greater than 120 nm, preferably not greater than 100 nm, and particularly preferably not greater than 80 nm or not greater than 70 nm, furthermore particularly preferably not greater than 60 nm or 50 nm.

Deviations from the plane are preferably partial areas of a surface which are elevated by a height H, also referred to hereinafter as “elevation” or “bump”, in relation to the corresponding plane, or are lowered by a depth T, also referred to hereinafter as “depression” or “dig-in”.

The height H designates the maximum height of an elevation or deviation, the depth T designates the maximum depth of a depression or deviation, i.e. the height H and the depth T each describe the maximum deviation from the plane of the respective surface.

Preferably, the first and/or the second surface of the at least one stack fulfill at least one of the following conditions:
no deviation from the plane of greater than 300 nm, wherein the deviation can be an elevation having a height H or a depression having a depth T;
ii) no elevation of greater than 200 nm,
iii) no depression of greater than 300 nm.

Preferably, the first and/or the second surface of the at least one stack fulfill at least one of the following conditions:
no deviation from the plane of greater than 50 nm, wherein the deviation can be an elevation having a height H or a depression having a depth T;
ii) no elevation of greater than 50 nm,
iii) no depression of greater than 100 nm.

Deviations from planes in the meaning of the present invention furthermore preferably have a length L and a width B, wherein the length is preferably at least 5 nm, preferably at least 20 nm, preferably at least 50 nm, preferably at least 100 nm or 500 nm, or preferably at least 5 μm, preferably at least 10 μm, preferably at least 500 μm, more preferably at least 1000 μm and/or the width is at least 5 nm, preferably is at least 10 nm, preferably at least 20 nm, preferably at least 50 nm or at least 150 nm, preferably at least 500 nm, more preferably at least 1000 nm. Preferably, the length L is not greater than 100 mm, preferably not greater than 50 mm and/or the width B is not greater than 3000 nm, preferably not greater than 2000 nm.

In the optical composite component according to the invention, such deviations alternatively or additionally occur in particular at the boundary surfaces between the areas of the surface of various optical and/or optically nonrelevant components, in particular at the boundary surfaces in areas of the surface which comprise the surfaces of components made of different materials and/or adhesive layers.

Boundary surfaces in the meaning of the invention are the areas of the surface of the composite component between the edge of the one first component and the edge of a directly adjoining second component. Such boundary surfaces are located in the composite component for example in the areas of the surface of the composite component at which a stack directly borders a further stack, a stack directly borders a further optical component, in particular a polarization-optical element, a stack directly borders an optically nonrelevant component, a further optical component, in particular a polarization-optical element, directly borders an optically nonrelevant component or an optically nonrelevant component borders an optical nonrelevant component, and in areas in which a substrate of a stack borders a further substrate of the stack.

Preferably, the first surface of the first component is planar and forms a first plane and the first surface of the directly adjoining second component is planar and formed a second plane, wherein the first plane and the second plane have a distance to one another of not greater than 1 μm, preferably not greater than 500 nm, preferably not greater than 250 nm; and/or the second surface of the first component is planar and forms a first plane and the second surface of the directly adjoining second component is planar and formed a second plane, wherein the first plane and the second plane have a distance of not greater than 1 μm, preferably not greater than 500 nm, preferably not greater than 250 nm. Preferably, the area of the first surface of the composite component which comprises or consists of the first surfaces of two directly adjoining components is planar and does not have a deviation from the plane of greater than 1 μm, preferably of greater than 500 nm, preferably greater than 250 nm and/or the area of the second surface of the composite component which comprises or consists of the second surfaces of two directly adjoining components is planar and does not have a deviation from the plane of greater than 1 μm, preferably of greater than 500 nm, preferably of greater than 250 nm.

The optical composite component preferably comprises a polarization-optical element which directly borders at least one further component, wherein the first surface of the polarization-optical element is planar and forms a first plane and the first surface of the directly adjoining further component is planar and forms a second plane, wherein the first plane and the second plane have a distance of not greater than 1 μm, preferably not greater than 500 nm, preferably not greater than 250 nm to one another; and/or the second surface of the polarization-optical element is planar and forms a first plane and the second surface of the directly adjoining second component is planar and forms a second plane, wherein the first plane and the second plane have a distance of not greater than 1 μm, preferably not greater than 500 nm, preferably not greater than 250 nm to one another.

The distance of one to the other plane is determined as follows:
determining the boundary surface at which one component borders the other component
determining the position at which the boundary surface or an extension of the boundary surface strikes the one plane
determining the distance from this position to the other plane, wherein the distance is determined along a normal vector of the one plane,
wherein the one plane is preferably defined as the plane which first intersects the boundary surface or the extension of the boundary surface originating from the mass area (“bulk”) of the optical composite component.

### Stack

According to the invention, the optical composite component comprises at least one stack, wherein the stack comprises two or more substrates, at least one inorganic coating and at least one adhesive layer, wherein the two or more substrates and the inorganic coating are arranged alternately along the stack direction.

### Substrates

Substrates according to the present invention each have a first and a second surface, which are preferably parallel to one another. The first and the second surface of a substrate are the so-called “main surfaces” of the substrates. The distance from the first to the second surface of the substrate is also referred to hereinafter as the thickness of the substrate.

The substrates preferably have a thickness of 0.2 mm to 2.0 mm, preferably of 0.3 mm to 1.8 mm, preferably of 0.4 to 1.7 mm, and particularly preferably of 0.5 to 1.5 mm.

The thicknesses of the substrates in the at least one stack can be different or identical.

The substrates preferably comprise a glass, a glass ceramic, an optoceramic or a plastic, preferably glass and/or plastic, particularly preferably glass, or consist thereof. The substrates preferably consist of a glass or a plastic, particularly preferably of a glass.

It is preferably a glass having an index of refraction n_{d} in the range of 1.45 to 2.30, preferably of 1.47 to 2.10, preferably of 1.50 is 2.00, likewise preferably of 1.47 to 1.8.

The two or more substrates preferably comprise a material which is transparent at least for a wavelength in the range of 450 nm to 650 nm, preferably is transparent for all wavelengths in the range of 450 nm to 650 nm, or preferably consist thereof.

In some embodiments, the at least one stack comprises substrates made of different materials; however, preferably all substrates in the at least one stack comprise the same material, preferably they consist thereof.

In embodiments in which the two or more substrates comprise or consist of a glass, the glass is preferably a silicate glass, for example a barium-containing silicate glass. For example, the substrate can comprise or consist of a flint glass or crown glass. The glass is optionally selected from alkaline earth-containing flint glass, a barium flint glass, a barium crown glass, a boron-containing crown glass, a lanthanum flint glass, a lanthanum crown glass, and combinations thereof.

The substrate preferably has a modulus of elasticity of 50 GPa to 150 GPa, preferably of 55 GPa to 100 GPa, more preferably of 65 GPa to 95 GPa, particularly preferably of 75 GPa to 90 GPa.

### Coating

According to the invention, the at least one stack comprises at least one inorganic coating.

The inorganic coating can comprise one or more layers; preferably, the coating comprises at least 2 layers. Preferably, the inorganic coating comprises 2 to 100 layers, preferably 4 to 50 layers, preferably 5 to 40 layers, particularly preferably 7 to 35 layers.

The inorganic coating preferably comprises one or more components selected from one or more oxides, one or more fluorides, one or more nitrides, one or more sulfides, one or more selenides, one or more metals, and combinations of two or more thereof. For example, the inorganic coating comprises or consists of one or more components selected from one or more metal oxides, one or more metal fluorides, one or more metal nitrides, one or more metal sulfides, one or more metal selenides, and combinations of two or more thereof. Oxides according to the present invention are preferably selected from silicon oxide, aluminum oxide, hafnium oxide, tantalum oxide, niobium oxide, titanium oxide, zirconium oxide, yttrium oxide, praseodymium oxide, scandium oxide, tin oxide, chromium oxide, indium oxide, and combinations of two or more thereof. In some embodiments, combinations of two or more oxides comprise mixed oxides.

Fluorides in the meaning of the invention are preferably selected from aluminum fluoride, magnesium fluoride, neodymium fluoride, lanthanum fluoride, yttrium fluoride, gadolinium fluoride, ytterbium fluoride, and combinations of two or more thereof.

Nitrides in the meaning of the present invention are preferably selected from aluminum nitride, silicon nitride, and combinations thereof. Sulfides in the meaning of the present invention are, for example, zinc sulfide. Selenides in the meaning of the present invention are, for example, zinc selenides. Metals in the meaning of the present invention are preferably selected from aluminum, silver, gold, chromium, nickel, and combinations thereof. The combination of two or more metals is optionally an alloy. The metallic layer preferably has a thickness of not greater than 10 nm in order to ensure sufficient transparency.

In one advantageous embodiment, the inorganic coating comprises at least one dielectric layer; preferably, all layers of the inorganic coating are dielectric layers.

In a further advantageous embodiment, the inorganic coating comprises at least one metallic layer, consisting of or comprising at least one metal, for example Ag, wherein the at least one metallic layer has a thickness of not greater than 10 nm.

The inorganic coating preferably has a thickness of 200 nm to 2000 nm, preferably of 300 nm to 1900 nm, more preferably of 400 nm to 1800 nm or 500 to 1700 nm, particularly preferably of 600 nm to 1600 nm.

In preferred embodiments, the inorganic coating is a multilayer coating, comprising two or more layers, wherein the respective layers have a thickness of 1 nm to 200 nm, of 4 to 100 nm, of 8 nm to 800 nm, of 10 nm to 700 nm, of 15 nm to 600 nm or of 15 nm to 500 nm.

The inorganic coating preferably has an index of refraction of 1.45 to 3.00, of 1.47 to 2.50, of 1.50 to 2.00 or of 1.51 to 1.90 or of 1.60 to 1.90. If the coating comprises more than one material, the specified index of refraction is the average index of refraction of the entire layer of the inorganic coating.

In advantageous embodiments, the inorganic coating has an index of refraction which corresponds to the index of refraction of the substrate. The ratio of index of refraction of the substrate to the index of refraction of the inorganic coating is preferably between 0.9 and 1.1, preferably between 0.95 and 1.05, more preferably between 0.98 and 1.03.

The two or more substrates and the at least one inorganic coating are arranged alternately along the stack direction in the at least one stack. The two or more substrates are preferably connected to one another via their surfaces, wherein the coating together with the adhesive layer represent the boundary surface between two substrates connected to one another.

The at least one stack has a first and a second surface and at least one boundary surface. Boundary surface in the meaning of the present invention refers to the surface between two substrates and comprises at least one inorganic coating and an adhesive layer. The boundary surface between two substrates preferably comprises an adhesive layer and at least one inorganic coating.

According to the invention, the at least one stack alternately comprises—and without taking into consideration the adhesive layers—substrates and inorganic coatings.

The stack according to the invention preferably alternately comprises—without taking into consideration the adhesive layers—a substrate (S) and an inorganic coating (B), wherein the combination (S-B) is repeated x times. In other words, the stack comprises (S-B)ₓ. In some embodiments, the stack comprises the sequence (S-B)ₓ-S. In some embodiments, the stack comprises the sequence B-(S-B)ₓ.

The at least one inorganic coating preferably has a modulus of elasticity of 60 GPa to 200 GPa, preferably of 80 GPa to 180 GPa, more preferably of 90 GPa to 160 GPa, particularly preferably of 100 GPa to 150 GPa. In inorganic coatings which contain two or more coating materials, the modulus of elasticity corresponds to the average modulus of elasticity of the entire layer of the inorganic coating.

### Adhesive

According to the invention, the at least one stack comprises at least one adhesive layer. The adhesive layer is used to connect the two or more substrates to one another flatly, preferably over the entire surface, wherein the substrates are connected to one another via their main surfaces.

The adhesive layer preferably comprises a light-curing adhesive, preferably a UV-curing adhesive.

The adhesive layer preferably has a layer thickness of 10 nm to 20 μm, preferably of 20 nm to 15 μm, preferably 50 nm to 10 μm, preferably of 100 μm to 7 μm, particularly preferably of 200 nm to 5 μm. The adhesive layer preferably has a layer thickness of 0.5 μm to 4.5 μm, preferably of 1.0 μm to 4.0 μm, preferably of 1.5 μm to 3.5 μm, particularly preferably of 2.0 μm to 3.0 μm. The adhesive layer preferably has a homogeneous thickness over the entire area of a substrate surface of the substrate that is covered thereby.

The adhesive layer preferably meets at least one of the following conditions:
a total thickness variation (TTV) of less than 20 μm;
ii) no inclusions having a particle size which is greater than the thickness of the adhesive layer;
iii) an index of refraction n_{d}, which deviates from the index of refraction n_{d} of the substrates not more than 0.005, preferably not more 0.004, preferably not more than 0.003, or not more than 0.002, particularly preferably not more than 0.001.

According to the invention, the adhesive layer has a total thickness variation, also referred to hereinafter as “TTV”, of less than 20 μm, preferably less than 15 μm, more preferably less than 12 μm, more preferably less than 10 μm, likewise preferably less than 7 μm, preferably less than 5 μm, preferably less than 4 μm or less than 3 μm, preferably less than 2.5 μm or less than 2 μm, preferably of less than 1.5 μm or less than 1 μm, particularly preferably less than 0.75 μm, more preferably less than 0.5 μm, more particularly preferably less than 0.3 μm or 0.2 μm. The above explanations on the meaning of the determination of the TTV apply analogously here.

The adhesive layer preferably does not comprise any inclusions having a particle size which is greater than the thickness of the adhesive layer. Inclusions in the meaning of the present invention are, for example, contamination and bubbles, such as air bubbles.

In advantageous embodiments, the at least one adhesive layer is formed from acrylate adhesives, epoxy adhesives, silicone adhesives, polyurethane adhesives, nanoparticle-filled acrylate adhesives, nanoparticle-filled epoxy adhesives, nanoparticle-filled silicone adhesives or nanoparticle-filled polyurethane adhesives, sol-gel adhesive systems, preferably from an acrylate adhesive, an epoxy adhesive, a silicone adhesive or a polyurethane adhesive, particularly preferably an acrylate adhesive.

The adhesive can be a light-curing adhesive, a heat-curing adhesive or an anaerobically curing adhesive. It is preferably a light-curing adhesive, preferably a UV-curing adhesive. The adhesive is preferably a light-curing, preferably UV-curing, acrylate adhesive.

The adhesive layer preferably has an index of refraction n_{d} which deviates from the index of refraction n_{d} of the two or more substrates not more than 0.005, preferably not more 0.004, preferably not more than 0.003, or not more than 0.002, particularly preferably not more than 0.001.

The UV-curing adhesive is preferably an optically clearer adhesive which preferably has an index of refraction n_{d} which essentially corresponds to the index of refraction n_{d} of the substrates and which preferably has low shrinkage upon curing. Tensions upon the adhesive bonding of the two or more substrates can be avoided or at least minimized in this way.

The adhesive layer preferably has a modulus of elasticity of 5000 MPa to 15 000 MPa, preferably of 6000 MPa to 12 000 MPa, more preferably of 7000 MPa to 10 000 MPa, particularly preferably of 7500 MPa to 9000 MPa.

The at least one stack is preferably produced using a method comprising the following steps:
a) providing two or more substrates, wherein the substrates have a first and a second surface which are parallel to one another, and wherein at least the first or the second surface of a substrate is provided with an inorganic coating,
b) connecting the two or more substrates using an adhesive layer, wherein a composite is obtained,
c) optionally dividing the composite.

In a particularly advantageous embodiment, the stack is produced according to the method described in DE 10 2023 108 065.2.

It is preferably true for the optical composite component that
i) the first surface and/or the second surface of the composite component has a roughness R_{q} of <5 nm; and/or
ii) the composite component has a TTV of less than 10 μm with respect to the first surface and the second surface; and/or
iii) the composite component has a warp of <100 μm with respect to the first surface and the second surface; and/or
iv) the composite component has a bow of <100 μm with respect to the first surface and the second surface.

The optical composite component preferably has a total thickness variation, also referred to hereinafter as “TTV”, of less than 10 μm, preferably of less than 8 μm, preferably of less than 5 μm, preferably less than 4 μm, more preferably less than 3 μm, particularly preferably less than 2 μm or less than 1 μm, more particularly preferably less than 0.75 μm, likewise particularly preferably less than 0.5 μm.

In some embodiments, the optical composite component has a TTV of at least 0.1 μm or at least 0.2 μm. Such optical composite components are particularly advantageous for the use of the produced stacks or the light guide elements manufactured therefrom for augmented reality applications. Optical composite components having low TTV can be produced, for example, by means of suitable abrasive methods such as grinding, lapping and/or polishing and/or by means of ion beam processing, as described in German patent application DE 10 2021 125 476.0 not yet published.

Preferably, the first and/or the second surfaces, preferably the first and the second surfaces of the optical composite component, have a roughness R_{q} of 0.1 nm to 5 nm, preferably not greater than 5 nm, preferably less than 5 nm, preferably less than 4 nm or less than 3 nm, more preferably of less than 2 nm or less than 1.5 nm, or particularly preferably less than 1 nm or less than 0.5 nm.

Preferably, the optical composite component has a warp of greater than 1 μm, greater than 5 μm, or greater than 10 μm, and/or less than 100 μm, preferably less than 50 μm, more preferably less than 20 μm, and/or a bow of greater than 1 μm, greater than 5 μm, or greater than 10 μm, and/or of less than 100 μm, preferably less than 50 μm, more preferably less than 20 μm. The optical composite component preferably has a bow and/or a warp of less than 0.1%, preferably less than 0.075%, preferably less than 0.05%, preferably less than 0.01% of the diameter. Warp and bow are preferably determined according to SEMI3D1203152015.

The bending (“warp”) and the bulging (“bow”) are characteristic variables which are used to express the shape of an optical composite which is at rest and is accordingly not held by a chuck, for example. The composite is accordingly mounted without force or rests on a planar underlay. The center surface in the thickness direction of the composite acts here as the measurement plane, wherein the best matching plane for the measurement plane is adopted as a reference plane. The warp represents the maximum value of the offset from the reference plane in relation to the measurement plane. The bow represents the difference between the reference plane and the measurement plane at the center of the substrate. If the composite is mounted by a locally bounded support, such as in the case of a 3-point mount or fork mount in the edge area, additional bends also occur under the influence of gravitational forces, which are referred to as sagging. The extent of these bends is therefore substantially dependent on the geometric arrangement of the support. Furthermore, the mechanical properties of the material and the geometric shape of the composite are parameters which determine the sagging.

The optical composite component preferably has a length and/or width of 10 mm to 300 mm, preferably of 20 mm to 150 mm, more preferably 30 mm to 100 mm, for example of 50 mm to 80 mm and/or a diameter of 10 mm to 300 mm, preferably 15 mm to 200 mm, preferably of 20 mm to 150 mm, more preferably 30 mm to 100 mm, for example of 50 mm to 80 mm.

In a further aspect, the invention comprises the use of the optical composite component according to the invention as or in an optical light guide element, in particular for augmented reality applications.

Deviations from the above-mentioned planes do not represent any intentionally introduced depressions and elevations which are introduced or applied, for example, for marking or alignment purposes on one or more areas of the first and/or second surface of the optical composite component.

### FIGURES

The invention will be described in more detail hereinafter on the basis of preferred embodiments and with reference to the appended drawings.

FIG. 1 schematically shows the side view of an embodiment of the optical composite component consisting of the at least one stack.

FIGS. 2a and 2b illustrate the stack direction in various embodiments of the at least one stack.

FIGS. 3 and 4 show various embodiments of the at least one stack which alternately contains substrate and coating.

FIG. 5 shows the side view of an embodiment of the at least one stack.

FIG. 6 shows the side view of an embodiment of the at least one stack.

FIG. 7 shows a three-dimensional representation of at least one stack.

FIG. 8 shows the top view of an optical composite component comprising a further optical component.

FIG. 9 shows the detail of a side view of an optical composite component comprising a further optical component.

FIG. 10 shows the general determination of the distance of two planes in a composite component from one another.

FIG. 11a shows a microscopy picture of the surface of an optical composite component according to the invention.

FIG. 11b shows the surface topography of the optical composite component according to FIG. 11a.

In the following detailed description, identical reference signs in the various embodiments each designate identical or identically acting assemblies and components. Insofar as there are essential functional deviations, these are each explained in more detail with reference to the affected embodiment.

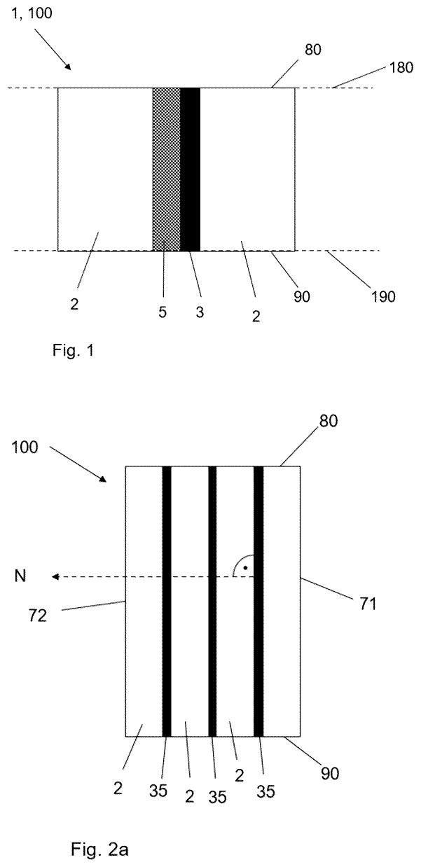

FIG. 1 schematically shows the side view of an embodiment of the optical composite component 100, consisting of the at least one stack 1. The optical composite component 100 or the at least one stack 1 comprises two substrates 2. One of the substrates 2 comprises a surface, which is provided with an inorganic coating 5. The second substrate 2 does not have an inorganic coating. The two substrates 2 are connected to one another over the entire surface by means of an adhesive layer 3. The stack 100 has a first surface 80 and a second surface 90, which are parallel to one another. The first surface 80 is in a first plane 180, the second surface 90 is in a second plane 190.

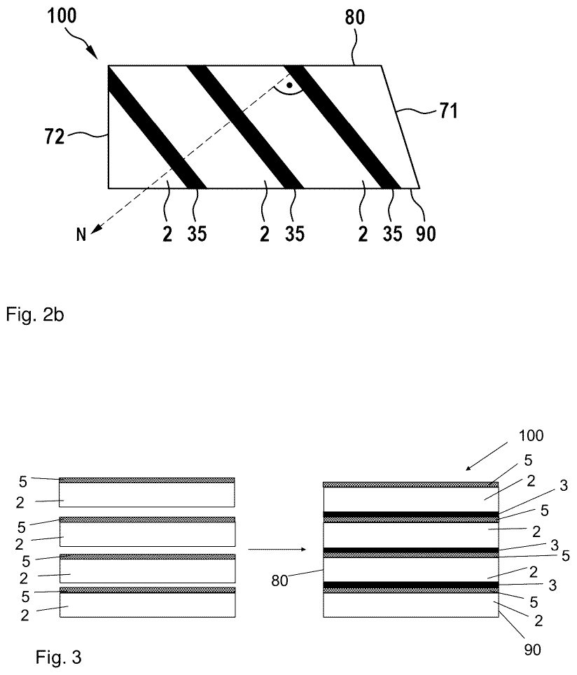

FIG. 2a and FIG. 2b illustrate the stack direction in various embodiments of the at least one stack 100. FIG. 2a shows a stack 100 which has a first surface 80 and a second surface 90 as well as a first lateral surface 71 and a second lateral surface 72. The stack 100 alternately comprises substrates 2 and a boundary surface 35 which is formed by an inorganic coating and an adhesive layer. The stacking of the substrates 2 takes place from the first lateral surface 71 to the second lateral surface 72 of the stack along the normal vector N of the boundary surfaces 35. The stack 100 is a so-called “straight” stack here, wherein the angle between the normal vector N and the first surface 80 and/or the second surface 90 is a right angle.

FIG. 2b shows a so-called skewed stack 100 which has a first surface 80 and a second surface 90 as well as a first lateral surface 71 and a second lateral surface 72. The stack 100 alternately comprises substrates 2 and a boundary surface 35 which is formed by an inorganic coating and an adhesive layer. The stacking of the substrates 2 takes place from the first lateral surface 71 to the second lateral surface 72 of the stack along the normal vector N of the boundary surfaces 35. The stack 100 is a so-called “skewed” stack here, wherein the angle between the normal vector N and the first surface 80 and/or the second surface 90 is not equal to 90°.

FIG. 3 shows the layer sequence in an embodiment of the at least one stack 100 which alternately comprises substrates 2, inorganic coating 5 and adhesive layers 3. The production of the stack 100 is carried out by successively connecting substrates 2, each of which has a surface provided with an inorganic coating 5, by means of full-surface adhesive layers 3.

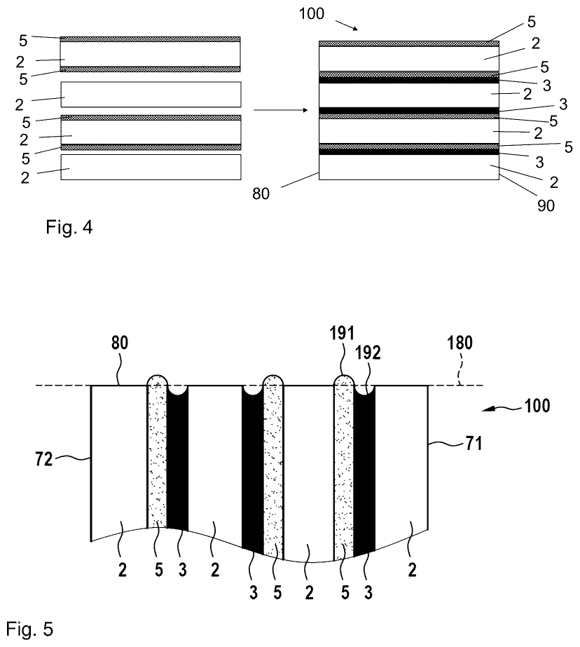

FIG. 4 shows the layer sequence in an alternative embodiment of the at least one stack 100 which alternately comprises substrates 2 and inorganic coating 5 and furthermore comprises adhesive layers 3. The production of the stack 100 is carried out by successively connecting substrates 2, each of which has two surfaces provided with an inorganic coating 5, and substrates 2, which have two uncoated surfaces, by means of full-surface adhesive layers 3.

FIG. 5 shows the detail of a side view of a stack 100. A first surface 80 is shown, which has deviations from the plane 180, wherein the deviations are elevations 191 and depressions 192. Stack 100 represents an embodiment which has an elevation 191 in the area of the surface 80, which is formed by or comprises inorganic coating 5, and has a depression 192 in the area of the surface 80 which is formed by or comprises an adhesive layer 3.

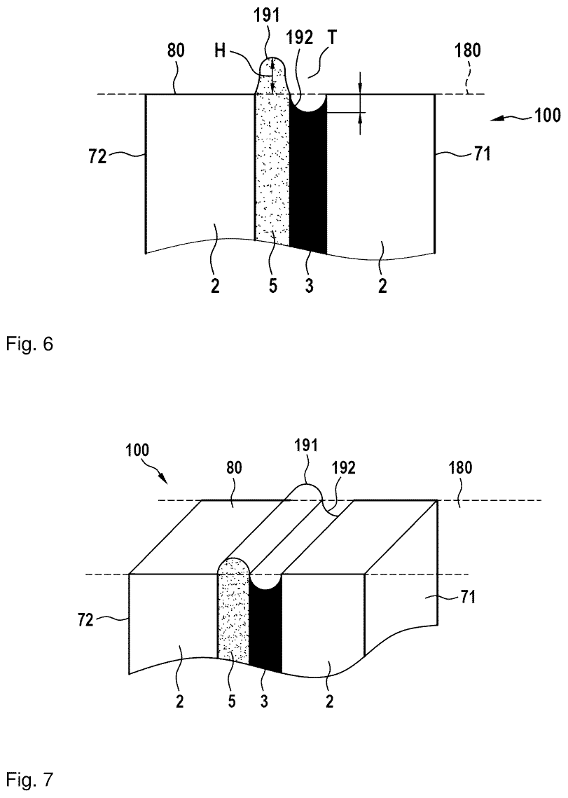

FIG. 6 shows the detail of a side view of a further stack 100. A first surface 80 is shown, which has deviations from the plane 180, wherein the deviations are elevations 191 having a height H and depressions 192 having a depth T. Stack 100 represents an embodiment which has an elevation 191 in the area of the surface 80, which is formed by or comprises inorganic coating 5, and has a depression 192 in the area of the surface 80 which is formed by or comprises an adhesive layer 3.

FIG. 7 shows the detail of a three-dimensional illustration of the top view of the first surface 80 of a stack 100. A first surface 80 is shown, which has deviations from the plane 180, wherein the deviations are an elevation 191 and a depression 192. The stack 100 represents an embodiment which has an elevation 191, which extends over the entire surface 80, in the area of the surface 80, which is formed by or comprises inorganic coating 5, and has a depression 192, which extends over the entire area of the surface 80, in the area of the surface 80, which is formed by or comprises an adhesive layer 3.

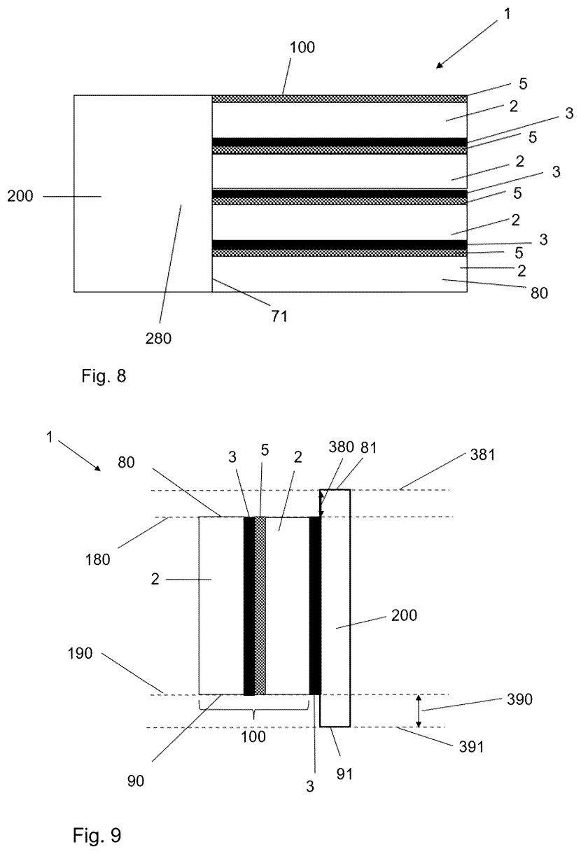

FIG. 8 shows the top view of an optical composite component which comprises a further optical component 200 in addition to at least one stack 100. The top view is of the first surface of the stack 100. Stack 100 and the further optical component 200 are preferably connected to one another over the entire surface, preferably by means of an adhesive layer (not shown), wherein a surface of the further optical component is connected to a lateral surface (in the illustrated case of the first lateral surface 71 of the stack 100). The first surface 80 of the stack 100 forms an area of the first surface 280 of the optical composite component 1 in this embodiment.

FIG. 9 shows the detail of a side view of an optical composite component which comprises a further optical component 200, which is directly adjacent to the stack 100, in addition to the at least one stack 100. The stack 100 having a first surface 80 and a second surface 90 comprises two substrates 2, an inorganic coating 5 and an adhesive layer 3 and is flatly connected to the further optical component 200 by means of an adhesive layer 3. The optical component 200 comprises a first surface 81, which forms a plane 381, and a second surface 91 which forms a plane 391. FIG. 9 shows the ideal case in which the planes 180 and 181 are parallel to one another. The first surface 80 of the stack 100 forms a plane 180, the second surface 90 of the stack 100 forms a plane 190. The distance 380 designates the distance from plane 180 to plane 381, the distance 390 designates the distance from plane 190 to plane 391.

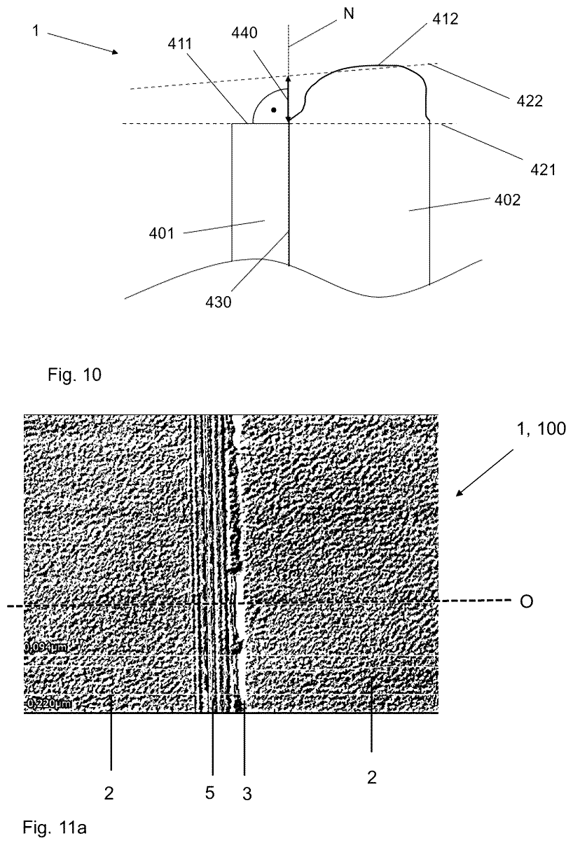

FIG. 10 illustrates the general determination of the distance of two planes in a composite component 1 from one another. A simplified illustration of two directly adjacent components of the optical composite component 1, comprising a first component 401 having a first surface 411, which forms a first plane 421, and a second component 402 having a first surface 412, which forms a second plane 422, is shown. The first component 401 and the second component 402 are connected to one another, wherein a boundary surface 430 results. Initially, the position at which the boundary surface 430 or an imaginary extension of the boundary surface 430 strikes the first plane 421 is determined. The distance 440 from this position to the second plane 422 is then determined, wherein the distance 440 is determined along a normal vector N of the first plane 421.

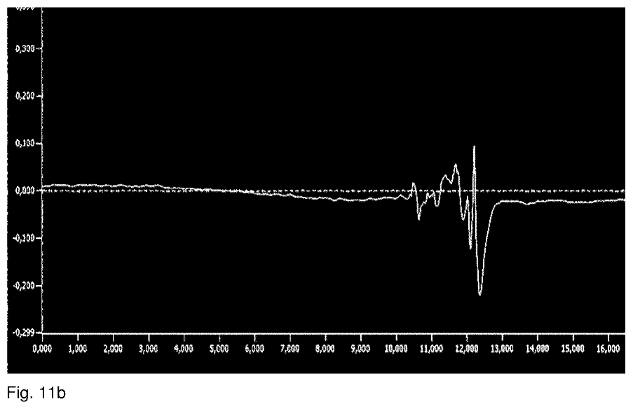

FIG. 11a shows in top view a microscopy picture of the surface of an optical composite component 1 according to the invention, consisting of a stack 100 which comprises two substrates 2, an inorganic coating 5 and an adhesive layer 3. The picture was obtained using a 3D laser scanning microscope VK-X3000 from Keyence by means of a confocal laser. The surface of the stack was modified by means of the method according to the invention. The substrates 2 consist of a glass of the following composition in wt. %:

| | |
|---|---|
| SiO₂ | 70.2 |
| B₂O₃ | 11.2 |
| Na₂O | 10.2 |
| K₂O | 7.1 |
| BaO | 1.1 |
| CaO | 0.2 |

A substrate 2 comprises a multilayer inorganic coating 5 having a thickness of thickness 1.7 μm. The two substrates 2 are flatly connected to one another via a UV-cured adhesive layer having a thickness of 0.4 μm.

The surface topography of the optical composite component was determined along the line O. The surface topography was likewise measured by the 3D laser scanning microscope VK-X3000 from Keyence by means of a confocal laser.

FIG. 11b shows the surface topography of the optical composite component according to FIG. 11a along the line O, shown by a solid line. The plane of the stack that results due to the surface of the stack 100 is shown by dashed lines and was calculated by means of a VK-X 3000 MultiFileAnalyser. FIG. 11b shows that the surface of the stack that was modified according to the invention only has minor deviations from the plane. The maximum height of a deviation is thus approximately 100 nm, the maximum depth of a deviation approximately 200 nm.

### LIST OF REFERENCE SIGNS

1 optical composite component
2 substrate
3 adhesive layer
5 inorganic coating
35 boundary surface
71 first lateral surface
72 second lateral surface
80 first surface of the stack
81 first surface of the optical component
90 second surface of the stack
91 second surface of the optical component
180, 381 first plane
190, 391 second plane
191 elevation
192 depression
100 stack
200 further optical component
280 first surface of the composite component
380, 390 distance between planes
401 first component
402 second component
411 first surface of the first component
412 first surface of the second component
421 first plane
422 second plane
430 boundary surface
440 distance between two planes
N normal vector of a plane
H height of a deviation
T depth of a deviation
O position for determining the surface topography

1. A method for surface modification of an optical composite component,
wherein the optical composite component has a first surface and a second surface,
wherein the optical composite component comprises a stack having a first and a second surface,
wherein the stack comprises two or more substrates, an inorganic coating and an adhesive layer, wherein the two or more substrates and the inorganic coating are arranged alternately along the stack direction,
wherein the angle between the normal vector of the first and/or of the second surface of the stack and the stack direction is not equal to 0°,
wherein the first surface of the composite component comprises the first surface of the stack and/or the second surface of the composite component comprises the second surface of the stack,
comprising the following steps:
a) providing a raw composite component;
b) optionally lapping or grinding an area of the first and/or of the second surface of the raw composite component;
c) polishing an area of the first surface and/or of the second surface of the raw composite component, preferably with a surface removal of 30 μm to 60 μm and/or a pressure of 50 to 1500 N and/or a rotational speed of 5 to 20 rpm and/or a slurry density of 1.02 to 1.1 g/cm³.

2. The method of claim 1, wherein step c) polishing takes place with a surface removal of 40 μm to 60 μm and/or a pressure of 100 N to 500 N and/or a rotational speed of 5 to 15 rpm and/or a slurry density of 1.04 g/cm³ to 1.07 g/cm³ and/or wherein the slurry comprises CeO₂.

3. The method of claim 1, wherein step b) preferably takes place with a surface removal of 50 μm to 400 μm, and/or a pressure of 50 to 1500 N, and/or a rotational speed of 5 to 20 rpm, and/or a coolant concentration of 10 vol % to 20 vol %, and/or using a pad comprising resin-bound diamond.

4. The method of claim 1, wherein the first surface and the second surface of the raw composite component are parallel to one another and/or the first surface of the at least one stack and the second surface of the stack are parallel to one another.

5. An optical composite component, in particular for use as an optical light guide element or in an optical light guide element,
wherein the optical composite component has a first surface and a second surface,
wherein the optical composite component comprises a stack having a first and a second surface,
wherein the stack comprises two or more substrates, an inorganic coating and an adhesive layer, wherein the two or more substrates and the inorganic coating are arranged alternately along the stack direction,
wherein the first and/or the second surface of the stack is planar and does not have a deviation from the plane of greater than 500 nm,
wherein the angle between normal vector of the first and/or of the second surface of the stack and the stack direction is not equal to 0°,
and wherein the first surface of the composite component comprises the first surface of the stack and/or the second surface of the composite component comprises the second surface of the stack.

6. The optical composite component of claim 5, wherein the first surface and the second surface of the optical composite component are parallel to one another and/or the first surface of the at least one stack and the second surface of the at least one stack are parallel to one another.

7. The optical composite component of claim 5, wherein the optical composite component and/or the stack has a thickness of 0.2 mm to 2.0 mm.

8. The optical composite component of claim 5, wherein the first and/or the second surface of the stack does not have any deviations from the plane of greater than 300 nm.

9. The optical composite component of claim 5, wherein the first and/or the second surface of the stack meets at least one of the following conditions:
i) no deviation from the plane of greater than 50 nm, wherein the deviation can be an elevation having a height H or a depression having a depth T;
ii) no elevation of greater than 50 nm, or
iii) no depression of greater than 100 nm.

10. The optical composite component of claim 5, wherein the two or more substrates have a first surface and a second surface, which are preferably parallel to one another and/or comprise or consist of a glass, a glass ceramic, an optoceramic or a plastic and/or have a thickness of 0.2 mm to 2.0 mm.

11. The optical composite component of claim 5, wherein the inorganic coating comprises at least 2 layers and/or has a thickness of 200 nm to 2000 nm and/or has an index of refraction which corresponds to the index of refraction of the substrates, wherein preferably the ratio of index of refraction of the substrates to the index of refraction of the inorganic coating is between 0.9 and 1.1.

12. The optical composite component of claim 5, wherein the adhesive layer is formed from a light-curing adhesive, preferably a UV-curing adhesive, and/or
wherein the adhesive layer has a layer thickness of 10 nm to 20 μm and/or
wherein the adhesive layer has an index of refraction n_{d} which deviates from the index of refraction n_{d} of the two or more substrates not more than 0.005.

13. The optical composite component of claim 5, wherein the composite component comprises at least one further stack and/or at least one further optical component selected from optical filters, in particular interference filters, mirrors, optical light guide elements and polarization-optical elements.

14. The optical composite component of claim 5, wherein the composite component comprises a polarization-optical element, wherein the polarization-optical element has a first surface and a second surface, and wherein the first surface of the composite component comprises the first surface of the polarization-optical element and/or the second surface of the composite component comprises the second surface of the polarization-optical element.

15. The optical composite component of claim 5, comprising a polarization-optical element which directly borders at least one further component, wherein the first surface of the polarization-optical element is planar and forms a first plane and the first surface of the directly adjoining further component is planar and forms a second plane, wherein the first plane and the second plane have a distance of not greater than 1 μm; and/or the second surface of the polarization-optical element is planar and forms a first plane and the second surface of the directly adjoining second component is planar and forms a second plane, wherein the first plane and the second plane have a distance of not greater than 1 μm.

16. The optical composite component of claim 14, wherein the polarization-optical element comprises a birefringent material.

17. The optical composite component of claim 5, wherein the optically relevant areas of the first and/or of the second surface of the composite component are planar, and do not have a deviation from the plane of greater than 1000 nm.

18. The optical composite component of claim 5, wherein
i) the first surface and/or the second surface of the composite component has a roughness R_{q} of <5 nm; and/or
ii) the composite component has a TTV of less than 10 μm with respect to the first surface and the second surface; and/or
iii) the composite component has a warp of <100 μm with respect to the first surface and the second surface; and/or
iv) the composite component has a bow of <100 μm with respect to the first surface and the second surface.

19. (canceled)

20. The method of claim 3, wherein step b) preferably takes place with a surface removal of 80 μm to 300 μm and/or a pressure of 100 N to 500 N, and/or a rotational speed of 5 to 15 rpm, and/or a coolant concentration of 10 vol % to 20 vol %.
